(19) United States
(12) Patent Application Publication
(10) Pub. No.: US 2025/0391101 A1
(43) Pub. Date: Dec. 25, 2025

(54) SYSTEM AND METHOD FOR REAL-TIME 3D RECONSTRUCTION OF VIDEOS

(71) Applicant: Amith Lankesar, London (GB)

(72) Inventor: Amith Lankesar, London (GB)

(21) Appl. No.: 18/755,981

(22) Filed: Jun. 27, 2024

(30) Foreign Application Priority Data
Jun. 22, 2024 (GB) GB2408983-1

(51) Int. Cl. G06T 15/20; G06T 15/00; G06T 15/50; G06T 17/20

(52) U.S. Cl. CPC G06T 15/20; G06T 15/005; G06T 15/50; G06T 17/20; G06T 2200/24

(57) ABSTRACT

A system and method for real-time 3D reconstruction of videos, converting 2D video frames into 3D video frames by generating depth maps using an artificial intelligence (AI) algorithm. The system separates depth maps from 2D video frames into RGB/A and depth components, maps the RGB/A component onto a 3D mesh based on UV coordinates, and adjusts the vertices according to the depth component. The rendered 3D video frames are displayed in real-time. The system integrates real-time sensor data to create dynamic parallax effects, locks the camera position onto target transforms within a 3D environment, and updates the camera's position and rotation based on device motion. Features include colorized depth maps, compression for efficient transmission, curved 3D meshes, shader programs for enhanced depth perception, gradient borders, dynamic orientation switching, and a user interface optimized for right-handed and left-handed users. Adaptive streaming technologies such as DASH and HLS are supported.

### FIELD OF THE INVENTION

The present invention relates to the field of digital media content creation and display technologies, specifically focusing on the generation and visualization of three-dimensional (3D) content from two-dimensional (2D) video frames. It encompasses advancements in artificial intelligence (AI), computer vision, and graphics processing to enable real-time 3D reconstruction and rendering on various display devices.

### BACKGROUND OF THE INVENTION

The consumption of digital video content has surged, with audiences increasingly seeking more engaging and immersive experiences. Traditional video content, primarily in two-dimensional (2D) format, dominates platforms ranging from educational resources to entertainment and advertising. While effective to a degree, 2D videos inherently lack depth and interactivity, which modern viewers, particularly those using smartphones and familiar with augmented reality (AR) and virtual reality (VR) technologies, find less engaging over time. The increasing availability of high-resolution screens and powerful processors in smartphones has heightened users' expectations for immersive content that can utilize the full potential of their devices.

The advent of AR and VR has hinted at the potential for more immersive content, yet these technologies often require users to have access to specialized hardware, such as headsets, which are not universally adopted due to cost, availability, and practicality concerns. AR and VR headsets, while providing a superior immersive experience, are expensive and cumbersome, limiting their adoption to niche markets. This creates a significant gap in the market: there is a growing demand for immersive content that can be easily accessed and viewed on widely available devices, like smartphones and tablets, without necessitating additional equipment. Technologies such as those described in the paper “NeuralRecon: Real-Time Coherent 3D Reconstruction from Monocular Video” (J. Sun, Y. Xie, L. Chen, X. Zhou and H. Bao, “NeuralRecon: Real-Time Coherent 3D Reconstruction from Monocular Video,” in 2021 IEEE/CVF Conference on Computer Vision and Pattern Recognition (CVPR), Nashville, TN, USA, 2021 pp. 15593-15602) highlight the complexity and hardware requirements of current methods, underscoring the need for more accessible solutions.

Moreover, current methods for creating 3D or holographic content are complex, time-consuming, and resource-intensive, limiting such content creation to professionals with specific technical skills and high-end equipment. Traditional 3D reconstruction methods, such as those using depth sensors and sophisticated computer vision algorithms, require significant computational power and expertise. These methods, while effective, are not easily accessible to the average content creator due to their complexity and resource demands. For example, the approach detailed in the article “Real-Time 3D Reconstruction Method Based on Monocular Vision” (Jia, Q., Chang, L., Qiang, B., Zhang, S., Xie, W., Yang, X., Sun, Y., & Yang, M. (2020). Real-Time 3D Reconstruction Method Based on Monocular Vision. Sensors, 21 (17), 5909) illustrates the resource-intensive nature of existing solutions. This restricts the diversity and volume of immersive content available, hindering widespread adoption and engagement.

The challenge, therefore, lies in developing a system and method that simplifies the displaying of 3D holographic videos, making this innovative form of content accessible to a broader range of creators and viewable on everyday devices. Such a development would not only democratize the consumption of immersive digital content but also significantly enhance viewer engagement by offering a novel, interactive experience. The system must overcome the limitations of current technologies, which either require specialized hardware, as in the case of VR headsets, or demand high technical proficiency and resources for content creation. By addressing these issues, the new method can fulfil the unmet need for accessible, immersive content that leverages the capabilities of common consumer devices like smartphones and tablets.

Existing technologies rely heavily on high computational requirements and specialized hardware setups. Such systems are adept at creating detailed 3D models but are often not suitable for real-time applications on consumer-grade devices. This complexity presents a barrier to widespread use and integration into everyday content creation workflows. Moreover, the reliance on sophisticated hardware and the need for extensive computational resources remain significant drawbacks. These systems highlight the potential for high-quality 3D reconstruction but also underscore the gap between professional-grade solutions and accessible consumer applications.

In light of these challenges, there is a pressing need for a solution that bridges the gap between advanced 3D reconstruction technologies and practical, user-friendly applications. The goal is to create a system that allows for real-time 3D reconstruction and rendering on commonly available devices without compromising on performance or quality. By leveraging the power of AI and optimizing processing techniques, it is possible to develop a method that simplifies the creation and display of immersive 3D content, making it accessible to a broader audience and usable in a variety of contexts, from education and entertainment to professional and creative industries.

Addressing these needs requires innovation in both the software algorithms and the hardware interfaces used for 3D reconstruction. By reducing the dependency on specialized equipment and focusing on efficient, real-time processing capabilities, the system can provide an enhanced user experience that meets the growing demand for interactive and immersive digital content. This development represents a significant step forward in making advanced 3D technologies more accessible and widely adopted.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present invention pertains to a system and method for real-time 3D reconstruction of videos, transforming two-dimensional (2D) video content into immersive three-dimensional (3D) visual experiences. Leveraging artificial intelligence (AI) algorithms, depth map generation, and sophisticated rendering techniques, the invention provides high-quality 3D visualizations displayable on various devices such as smartphones, augmented reality (AR) headsets, and virtual reality (VR) systems.

The process begins with receiving a 2D video frame at a processing system, which serves as the input for transformation. An AI algorithm processes the visual data in the 2D video frame to determine spatial geometry, generating a depth map. This depth map, which can be in grayscale or colorized format, offers detailed distance information for each pixel in the frame. The system separates the depth map from the 2D video frame into distinct RGB/A (color) and depth components. Using UV coordinates, the RGB/A component is then mapped onto a 3D mesh, ensuring the texture of the video frame aligns correctly with the 3D mesh and creating a coherent 3D representation. The vertices of the 3D mesh are adjusted according to the depth component derived from the depth map, shaping the mesh to reflect the accurate spatial geometry of the original 2D video content. The adjusted 3D video frame is then rendered on a display device in real-time, crucial for applications requiring immediate visual feedback, such as AR and VR experiences.

The system enhances user experience by integrating real-time sensor data from devices, including gyroscope and accelerometer readings, to adjust the perspective of the 3D video frame, creating a dynamic parallax effect. This effect enhances depth perception and interactivity as it adjusts to user movements. Additionally, the system locks a virtual camera position onto a target transform within the 3D environment, continuously updating the camera's position and rotation based on device motion to maintain the 3D illusion. This ensures the 3D content remains stable and accurately oriented relative to the user's viewpoint. To optimize transmission, the depth map can be compressed, reducing file size and bandwidth requirements. The combined RGB/A and depth map data can be transmitted using adaptive streaming technologies such as Dynamic Adaptive Streaming over HTTP (DASH) or HTTP Live Streaming (HLS).

A shader program is applied to render the 3D vertices, enhancing depth perception and visual realism. This program can also add transparent gradient borders to the edges of the 3D mesh, minimizing visual anomalies and enhancing aesthetic appeal. The system integrates 3D video content with user interface (UI) elements optimized for both right-handed and left-handed users, ensuring accessible and efficient interaction across various devices. Furthermore, the display device can dynamically switch between landscape and portrait orientations, with the 3D rendering adjusting accordingly to maintain a consistent and immersive viewing experience.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

The content presented here is depicted as illustrative examples rather than restrictive depictions in the accompanying figures. To enhance the simplicity and comprehensibility of these illustrations, the elements shown are not to be interpreted as being to exact scale. In certain instances, the size of some elements may be intentionally enlarged in comparison to others to facilitate a clearer understanding. Additionally, when it is deemed suitable, the same reference markers may be utilized across multiple diagrams to signify elements that are equivalent or have similar functions. The invention will now be described by the way of example and reference to the accompanying diagrams in which;

FIG. 1A shows a block diagram of the general depiction of a system as per one configuration of the current invention;

FIG. 1B shows a block diagram of a user device with more detail;

FIG. 2 shows a method of processing video for 3D representation;

FIG. 3A is an illustration of a curved 3D wireframe mesh with front and side views;

FIG. 3B is an illustration of a flat rectangular 3D wireframe mesh with front and side views;

FIG. 4A is an illustration of a curved 3D wireframe mesh and how it appears on a smartphone;

FIG. 4B is an illustration of a flat rectangular 3D wireframe mesh and how it appears on a smartphone;

FIG. 4C is an illustration of a 3D logo on the smartphone screen, demonstrating the depth effect enhancing the user's perception of three-dimensionality;

FIG. 5 is an illustration that presents a comprehensive depiction of potential configurations for landscape-oriented videos for the depth-mapped output images, which are synthesized and amalgamated from a provided 2D video frame as the input;

FIG. 6 is an illustration that presents a comprehensive depiction of potential configurations for portrait-oriented videos for the depth-mapped output images, which are synthesized and amalgamated from a provided 2D video frame as the input;

FIG. 7 shows a system for utilizing smartphone sensors to enhance 3D content viewing experience using a camera movement program;

FIG. 8 shows the parallax program used for utilizing hardware sensors to enhance 3D content viewing experience;

FIG. 9 shows the shader program used for utilizing hardware sensors to enhance 3D content viewing experience;

FIG. 10A is an illustration of the forward-facing camera, locked to a target transform with the orbital movement restrictions;

FIG. 10B is an illustration of the side-facing camera, locked to a target transform but moving in the left direction with the orbital movement restrictions;

FIG. 10C is an illustration of the side-facing camera, locked to a target transform where the 3D video or 3D content has moved in the clockwise direction, facing the camera;

FIG. 11 is an illustration of the forward-facing camera, locked to a target transform with the orbital movement restrictions regardless where the 3D content placed (stationary or moving);

FIG. 12 is an illustration of a 3D video mesh from the front bottom view, front top view and side view;

FIG. 13A is an illustration of the sensors within a smartphone in landscape orientation, but this can apply to any device with the motion sensor;

FIG. 13B is an illustration of a 3D video mesh from the front bottom view, showing how the parallax program morphs the 3D mesh with the movement from the sensors on the user device;

FIG. 14A is an illustration of the default or right-handed user interface (UI) for quick access to 3D content, representing where the channels, content links and 3D content should be located;

FIG. 14B is an illustration of the default or left-handed UI for quick access to 3D content, representing where the channels, content links and 3D content should be located;

FIG. 14C shows the UI layout optimized for right-handed users on a smartphone, demonstrating the efficient one-finger access to content by the thumb;

FIG. 14D shows the UI layout optimized for left-handed users on a smartphone, demonstrating the efficient one-finger access to content by the thumb.

### DETAILED DESCRIPTION

The following detailed description refers to the accompanying drawings, which illustrate specific embodiments of the invention. The descriptions provide clarity on the structure and operational functionality of the various system components, methods and user devices depicted in the drawings. The intention is to furnish comprehensive details that will enable those skilled in the pertinent technical field to practice the invention based on the representations and instructions herein. Reference numbers are consistently applied across multiple figures to denote identical or functionally similar elements, highlighting the cohesive nature of the system's design and operation.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, inventive subject matter lies in less than all features of a single disclosed embodiment. Thus, the following claims are hereby incorporated into the detailed description, with each claim standing on its own as a separate embodiment.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries should be interpreted as having a meaning that is consistent with their meaning in the context of the relevant art and will not be interpreted in an idealized or overly formal sense unless expressly so defined herein.

### 1. Overview

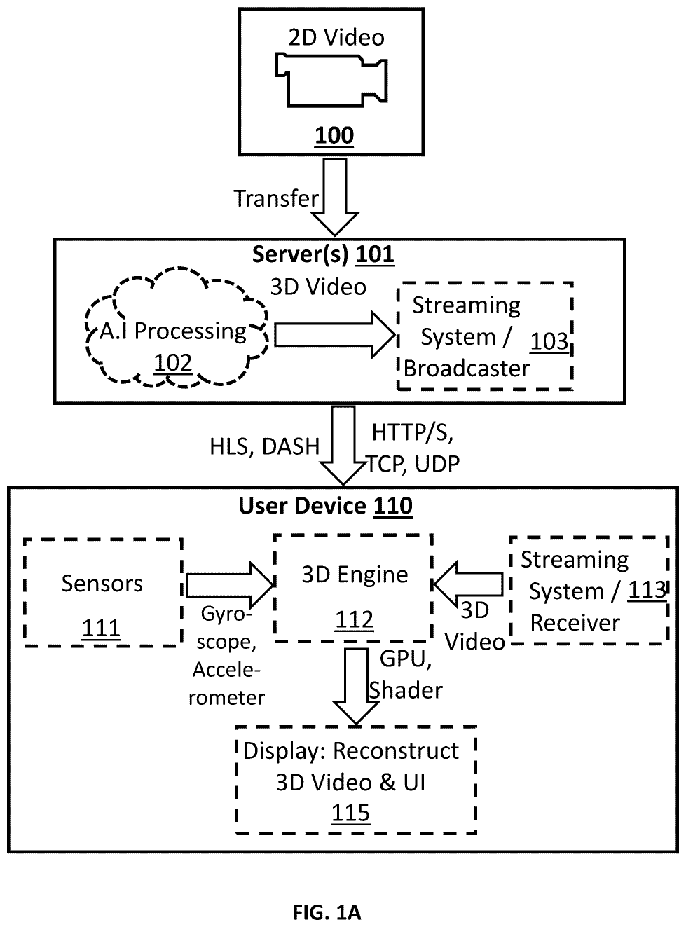

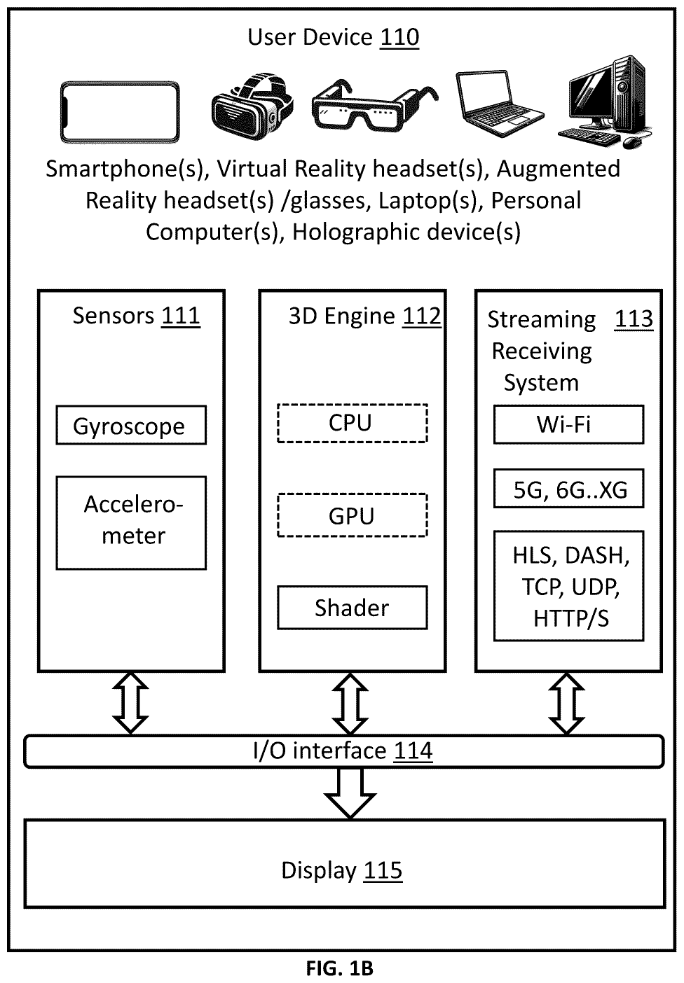

As shown in FIG. 1A illustrates a high-level block diagram of a system for converting two-dimensional (2D) video content into three-dimensional (3D) video, which is subsequently available for streaming. The system commences with the 2D Video source 100, which is provided to Server(s) 101 for processing. Incorporated within the Server(s) is an Artificial Intelligence (AI) Processing module 102 that facilitates the conversion of 2D video into 3D format. The processed 3D video is then routed to a Streaming System/Broadcaster 103. The system employs various transmission protocols such as HTTP/S, TCP, UDP and streaming protocols but limited to HLS, DASH to disseminate the 3D content to User Devices 110.

Continuing to FIG. 1B, we observe a detailed schematic of the User Device 110. This device can take various forms including, but not limited to, smartphones, virtual reality headsets, augmented reality glasses, laptops, personal computers, or holographic devices, each capable of providing an immersive 3D viewing experience. Integral to the functionality of the User Device 110 are Sensors 111, which encompass a gyroscope and an accelerometer, allowing for the detection of device orientation and motion. The device's 3D Engine 112, consisting of a CPU, GPU, and Shader, manages the processing and rendering of 3D content. The Streaming Receiving System 113 includes connectivity options such as Wi-Fi and various wireless network technologies (e.g., 5G, 6G, etc.), along with support for multiple streaming protocols. The I/O Interface 114 facilitates communication between the device's components or with external devices. Finally, the Display 115 serves as the visual interface for the user, presenting the reconstructed 3D video content alongside the device's user interface. In both figures, common reference numerals are utilized to indicate components that are carried over from one figure to another. For instance, element 110 in both FIG. 1A and FIG. 1B refers to the user device that ultimately receives and displays the 3D content. Similarly, elements 111, 112, and others that appear in both figures indicate that these elements serve the same or similar functions within the described system.

### 2. a System for Displaying Holographic or Three-Dimensional (3D) Videos

The disclosed system is a comprehensive framework for converting traditional two-dimensional (2D) video input into an interactive, three-dimensional (3D) holographic display, suitable for a multitude of user devices. FIG. 1A delineates the overarching process flow, beginning with the 2D video source (100), which is transferred to server(s) (101). These servers are equipped with an AI processing module (102), responsible for the generation of 3D video data by interpolating depth information from the 2D input, creating a multi-dimensional frame that includes both color (RGB/A-red green blue or red green blue alpha)) and depth data (colorized or grayscale). The streaming system (103) then broadcasts this data via various transmission protocols including but not limited to HTTP/S, HLS, DASH, TCP, and UDP, ensuring broad compatibility and robust streaming performance.

At the user's end, depicted in FIG. 1B, the user device (110) is equipped with an array of sensors (111), including gyroscopes and accelerometers. These sensors are integral to the system's ability to adjust the video output in real-time, responding to the user's movements to maintain the illusion of depth and space, providing an interactive and immersive 3D video experience. The 3D Engine (112) leverages the graphics processing unit (GPU) or/and central processing unit (CPU) of the device to execute complex shader programs that manipulate the texture and depth data, rendering the 3D video onto a mesh which is then displayed to the user through the display interface (115).

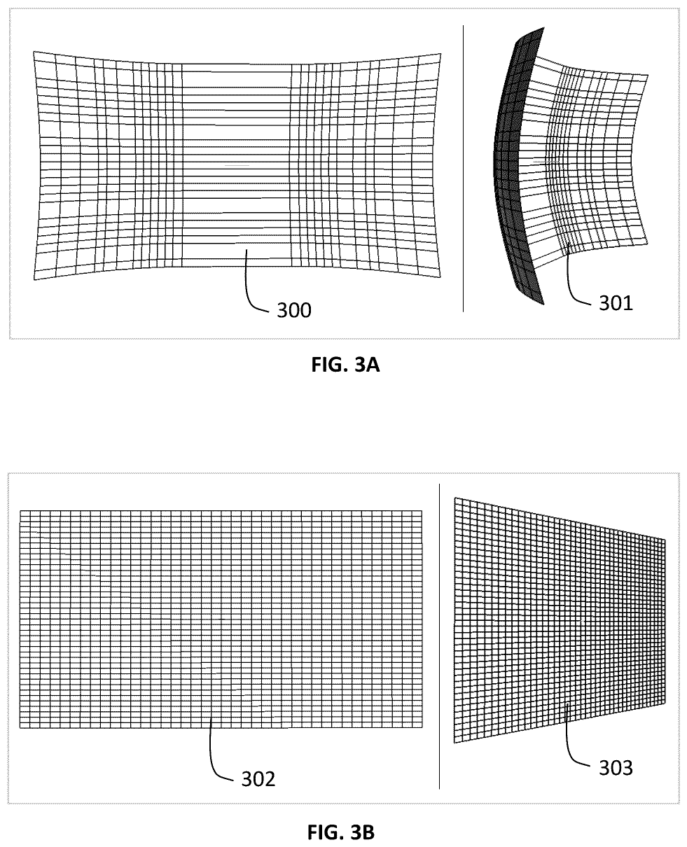

As shown in FIGS. 3A and 3B, a flat rectangular and curved rectangular mesh wireframe front view (300, 302), and side views 301 and 303. The curvature imbued into the mesh serves to enhance depth perception, thereby fostering a more realistic and engaging visual experience. This curvature is not static but dynamically computed using the system's shader programs, which adjust the mesh in real-time according to the depth information received. flat rectangular mesh is intended for scenarios where precision and realism in the viewing experience are paramount. Both the flat and curved meshes can be generated in real-time by the system or pre-constructed using 3D modelling software, depending on the requirements of the display.

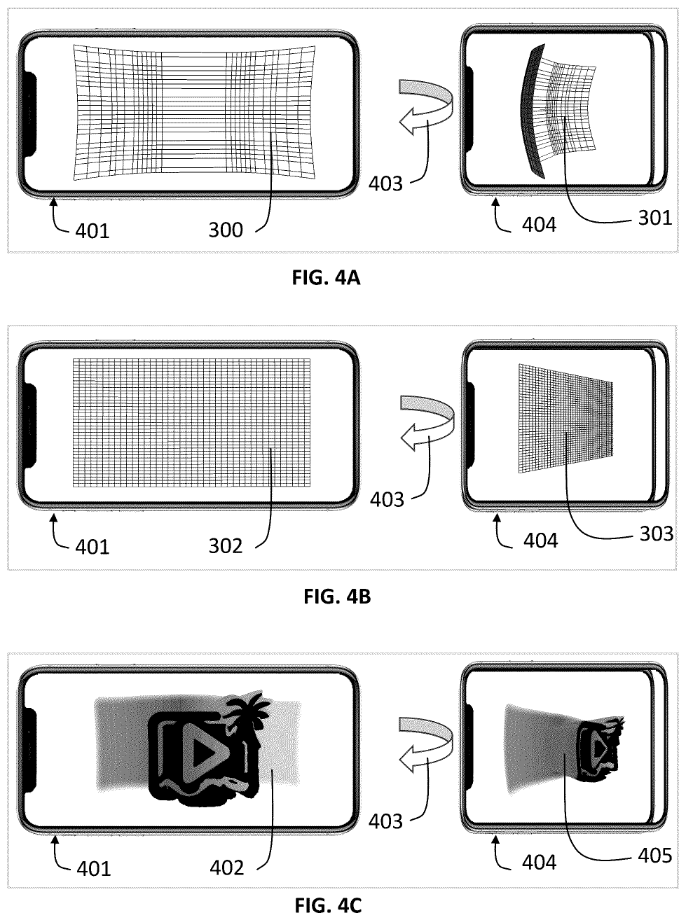

### Description for FIGS. 4A and 4B:

As shown in FIGS. 4A and 4B, we see a smartphone that presents the wireframe mesh from a frontal perspective and, when the device's gyroscope or accelerometer detects rotation, a side view is revealed. The images demonstrate how the mesh (400, 401) appears on the display (402) and how it transforms when the smartphone is rotated in a clockwise direction (403). This transformation highlights the interactivity enabled by the device's sensors, allowing the mesh to present a convincing 3D effect that changes with the device's orientation. As shown in FIG. 4C illustrates how a 3D logo appears on a smartphone display. The logo features a triangular play symbol at its center, flanked by a palm tree on the right and a wave pattern at the bottom (402). The darker areas of the logo, especially the vertices around the play symbol, are visually extruded from the base mesh, creating a pronounced 3D effect that enhances the logo's dimensional qualities. When the smartphone is rotated (404), the side view (405) becomes more prominent, accentuating the extrusion and showcasing the depth that the mesh is capable of rendering.

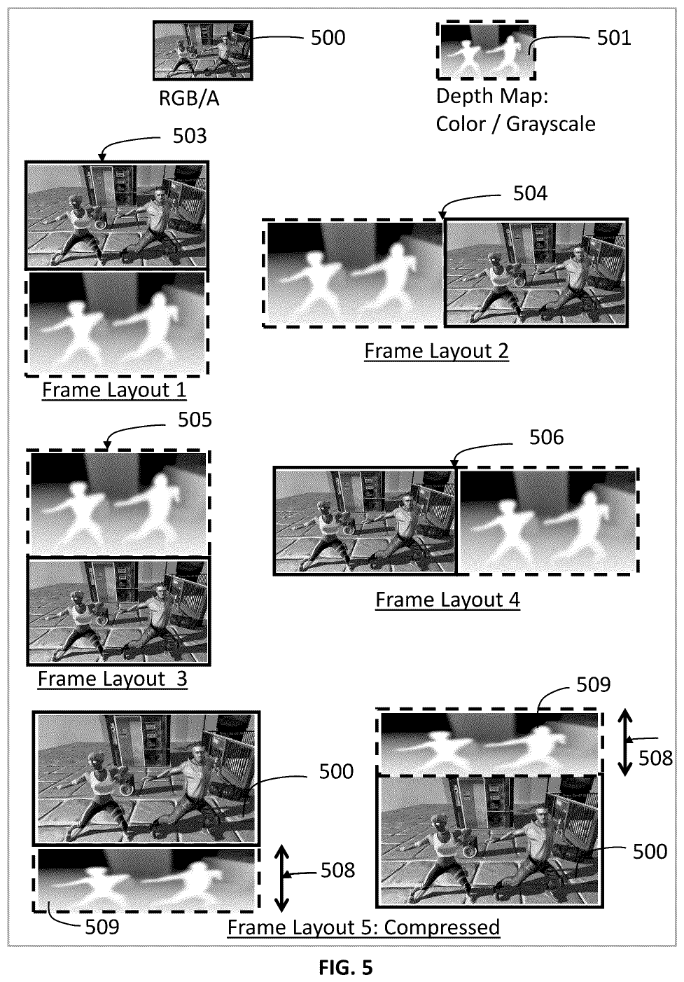

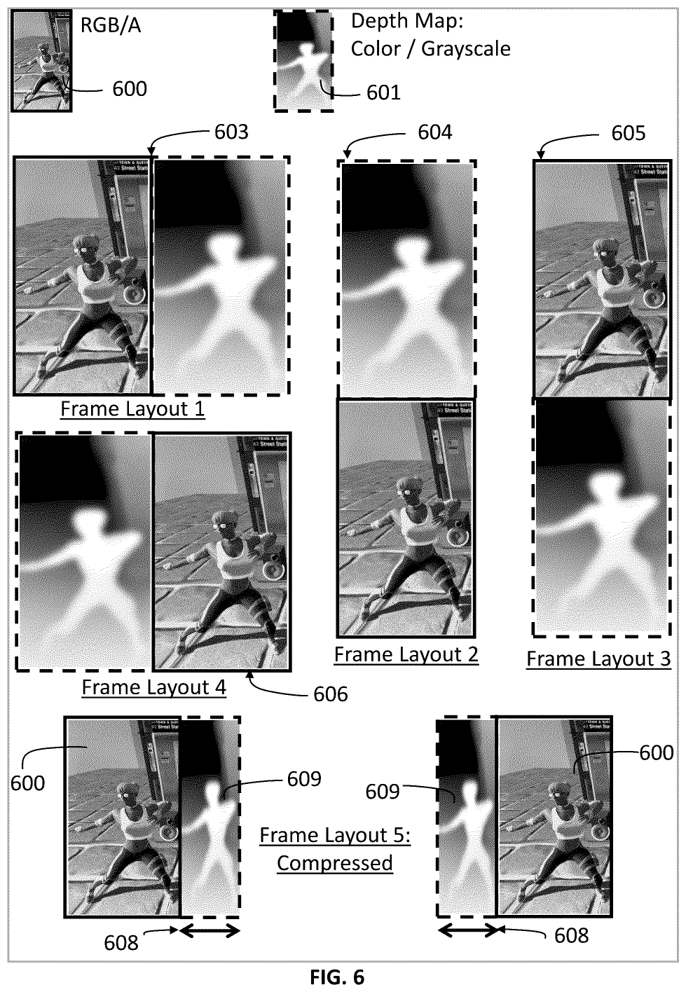

As shown in FIGS. 5 and 6 illustrate the treatment of video frames within the system of a male and female 3D animated dancers. The RGB/A video frames (500, 600) are paired with depth maps (501, 601) to construct a comprehensive data set that the shader program utilizes to render the 3D video. Various frame layouts, from uncompressed (501, 601) to compressed (509, 609), are supported, demonstrating the system's flexibility and its ability to optimize for both transmission efficiency and display fidelity.

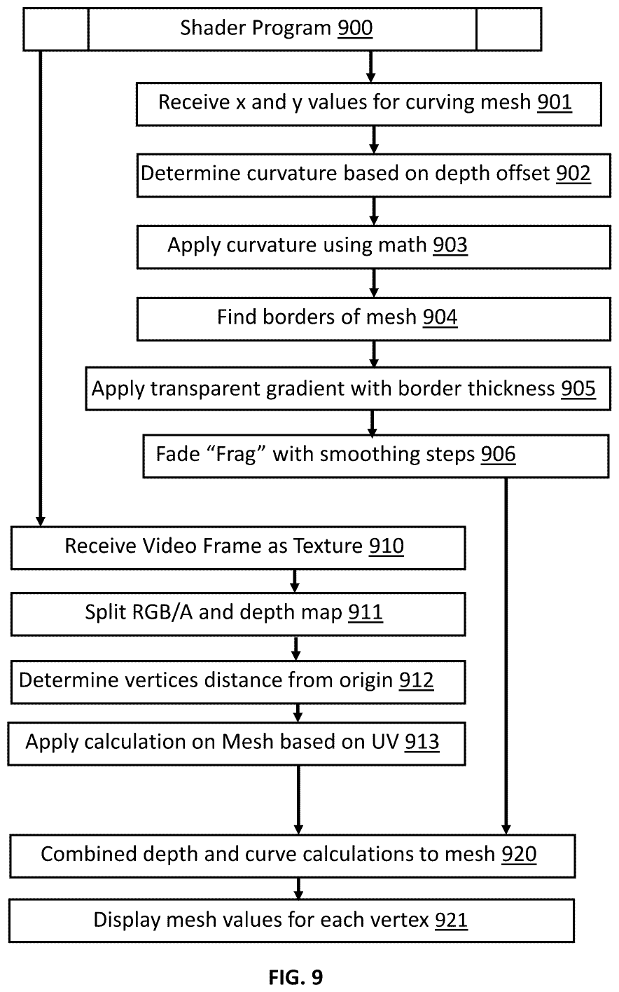

The detailed operation of the shader program is encapsulated in FIG. 9. The program (900) commences by receiving coordinates (901) that dictate the curvature of the mesh, adjusts vertex displacement based on depth (902), and applies the curvature mathematically (903). It identifies the periphery of the mesh (904) and enacts a transparent gradient effect at the borders (905) to create a smooth visual transition at the mesh edges. Furthermore, the program methodically fades these edges (906) to prevent abrupt transitions that could disrupt the 3D illusion.

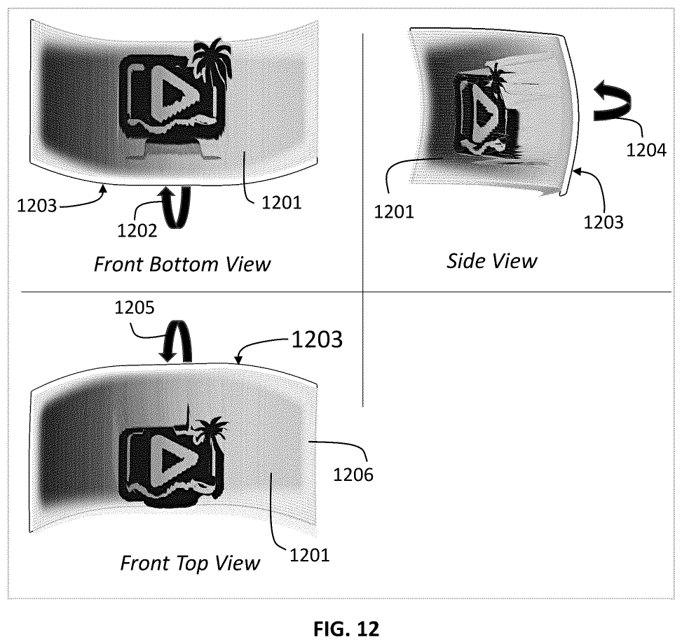

As shown in FIG. 12, multiple views of the curved mesh display are provided, illustrating the versatility of the display system in maintaining a consistent and convincing 3D representation from various angles. The front-bottom (1202) and front-top (1205) views, along with the side perspective (1204), showcase the system's ability to deliver a uniform and continuous holographic image, adaptable to the user's position and device orientation.

### 3. a Method of Processing Video for 3D Representation

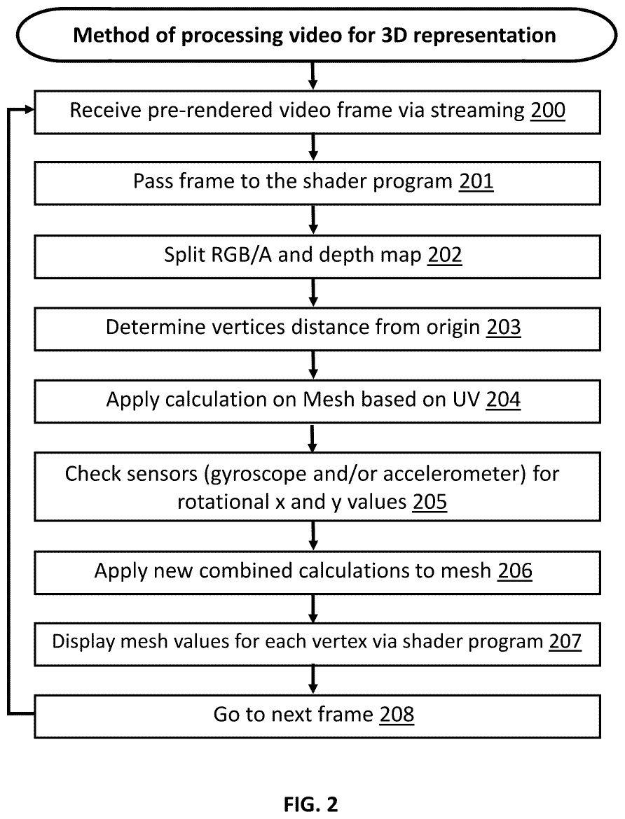

The method described herein pertains to the advanced processing of video content to create a 3D representation that can be perceived on various devices. This innovative process begins with the reception of a pre-rendered video frame via streaming, as depicted in the operational flowchart of FIG. 2, step 200. The video frame, which is received in a standard RGB/A format, is passed to a specialized shader program (FIG. 9) within the user device's processing system (201).

Upon reaching the shader program, the video frame is subject to a meticulous separation process, wherein the RGB/A data is methodically disentangled from the depth map information (Step 202, FIG. 2). This bifurcation is pivotal, facilitating the independent adjustment of color and depth variables which is quintessential for the rendering of a three-dimensional image. The depth map, an intricate representation of the video's spatial geometry, may manifest in a monochromatic grayscale format or as a vibrant colorized depth image. These depth maps are not arbitrarily created but are the product of a sophisticated AI algorithm designed to process individual frames or an entire sequence of frames from the video stream.

To accommodate the diverse orientations in which the video content might be displayed, FIG. 5 and FIG. 6 delineate the distinct frame layouts for landscape and portrait orientations, respectively. In FIG. 5, the landscape orientation, a wider field of view is presented, whereby the depth information and RGB/A data are aligned in a configuration that maximizes horizontal space. The layout is intentionally structured to harmonize with the natural eye movement that sweeps across the horizon, thus enhancing the perception of depth in the scenery or action unfolding within the frame. Conversely, FIG. 6 illustrates the portrait orientation, in which the vertical dimension is emphasized, allowing for a longer, continuous scroll of video content. This orientation is adeptly suited for displaying characters or subjects in detail, as it closely mirrors the human form. The layouts are not merely static but can dynamically switch between orientations, ensuring an optimal viewing experience that adapts to the user's device orientation and preference.

FIG. 5—Landscape Orientation Frame Layouts:

Element 500—RGB/A Video Frame: This is the primary image frame that contains the color information in the red, green, blue, and/or alpha channels, which define both color and transparency.

Element 501—Depth Map (Color/Grayscale): This image represents the depth data for each pixel in the RGB/A video frame. It can be in grayscale, where depth is represented by shades of gray, or in color, which can represent depth with a broader range of values.

Element 502—Connection Line: It visually connects the RGB/A video frame to the depth map, indicating that these two components are associated with each other for the process of 3D rendering.

Element 503—Frame Layout 1: The first example of a frame layout where the RGB/A and depth map are placed adjacent to each other. A top-down approach where the RGB/A frame is on top.

Element 504—Frame Layout 2: A variation on the frame layout, which may show a different method of organizing or encoding the RGB/A and depth information for processing or display purposes. A left-right approach where the depth data frame is on the left.

Element 505—Frame Layout 3: Another layout configuration, which might illustrate an alternative way of integrating RGB/A and depth data. A top-down approach where the depth data frame is on top.

Element 506—Frame Layout 4: Demonstrates a further variation of frame layout, which might involve another unique method of data arrangement. A left-right approach where the RGB/A frame is on the left.

Element 508 and 509 (part of Frame Layout 5—Compressed): These elements are involved in the compression of the frame layout:

Element 508: Arrows depict the action of compressing the depth map data to reduce frame size.

Element 509: The outcome of the compression process, showing the combined RGB/A and depth map in a format that is smaller. 508 and 509 use the top-down approach but the compression process also applies to the left-right approach.

FIG. 6—Portrait Orientation Frame Layouts:

Element 600—RGB/A Video Frame: The primary image frame in portrait orientation containing RGB and alpha channel data.

Element 601—Depth Map (Color/Grayscale): The depth information for the RGB/A frame, which can be presented as a grayscale or color depth map, indicating the z-axis information of the video frame.

Element 602—Connection Line: Similar to element 502, it signifies the relationship between the RGB/A frame and the depth map in the portrait orientation

Element 603—Frame Layout 1: The portrait equivalent to element 503, showing the RGB/A and depth map arranged in a manner suitable for portrait-mode displays. A left-right approach where the RGB/A frame is on the left.

Element 604—Frame Layout 2: Another frame layout for portrait orientation, perhaps for a different processing method or display requirement that is specific to portrait mode. A top-down approach where the depth data frame is on top.

Element 605—Frame Layout 3: Yet another variation of the portrait frame layout, which might cater to different 3D rendering techniques or the needs of particular portrait-oriented display hardware. A top-down approach where the RGB/A frame is on top.

Element 606—Frame Layout 4: Illustrates a fourth layout variant within the portrait orientation, emphasizing the system's adaptability to diverse processing and rendering needs in this mode. A left-right approach where the depth data frame is on the left.

Element 608 and 609 (part of Frame Layout 5-Compressed): These elements illustrate the compression process for portrait orientation:

Element 608: Shows the direction of compression, similar to element 508, but optimized for portrait-mode frames.

Element 609: Represents the final compressed layout, where the RGB/A and depth data are combined into a compact form.

508 and 509 use the left-right approach but the compression process also applies to the top-down approach.

In both instances, the alignment of RGB/A and depth information is calibrated to support a transition between orientations. This is not a trivial feature; it ensures that whether the viewer prefers a broad panoramic view or a towering vertical display, the 3D rendering remains uninterrupted and consistent. It is this agility and responsiveness in the handling of complex video data that underpin the advanced capability of the system to deliver an immersive 3D video experience.

The next step involves determining the vertices' distance from the origin of the 3D space (203). This step is crucial for understanding how far each point in the video frame is from a viewer's perspective, which in turn informs how the points will be manipulated to create the perception of depth. Following this, calculations are applied to the mesh based on UV coordinates, which dictate how the texture is mapped onto the mesh (204). This process allows the texture to deform in a way that mimics the contours and depth of the objects within the video frame.

The system then checks the sensors (205), such as gyroscopes and accelerometers, for the device's rotational x and y values. This data is used to adjust the video's 3D representation in real-time, aligning it with the user's perspective and motion to ensure a consistent and immersive viewing experience.

Subsequently, the new combined calculations are applied to the mesh (206), effectively altering the mesh's vertices to create a 3D effect that matches the depth information. Each vertex is repositioned in 3D space to simulate the appropriate depth, creating the illusion of a three-dimensional scene on a two-dimensional screen.

The mesh, now carrying the updated vertex values, is displayed through the shader program (207). This process involves rendering the textured mesh in such a way that the viewer perceives a 3D video. The system ensures that the 3D representation is maintained across successive video frames, providing a seamless and continuous 3D experience as the viewer watches the video content.

Finally, the system prepares to continue the process with the subsequent frame (208), ensuring that the 3D effect is sustained throughout the duration of the video playback.

This detailed description encapsulates a novel method for processing video for 3D representation, leveraging the synergy of AI algorithms, shader programs, and real-time sensor data to create an immersive 3D viewing experience.

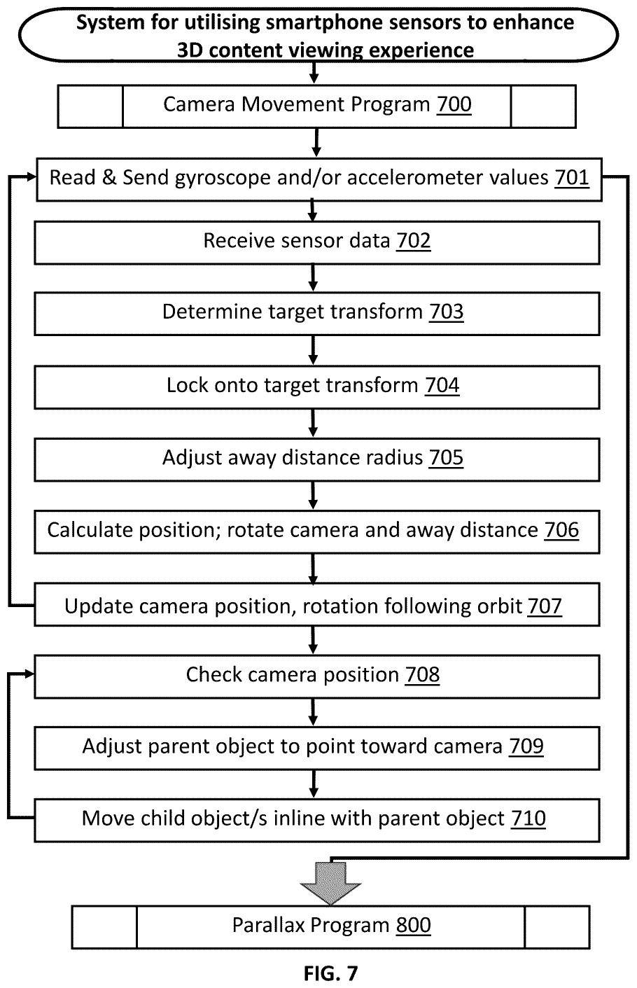

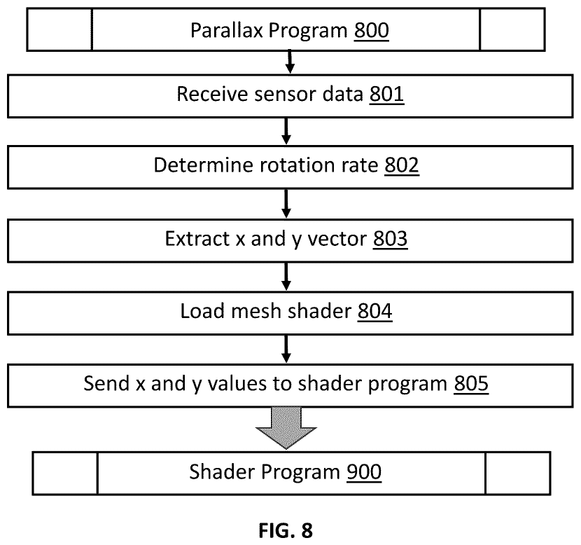

A system for utilizing smartphone sensors to enhance 3D content viewing experience The embodiments of the inventive system are graphically depicted in FIG. 7 and FIG. 8, which present the flowcharts of the operational sequences executed by the system to enhance the viewing experience of 3D content or 3D video on a user device utilizing sensor input.

The system comprises several functional steps which can be realized through one or more software modules or programs. The method includes three programs, namely: Camera Movement Program 700 (FIG. 7), Parallax Program 800 (FIG. 8) and Shader Program 900 (FIG. 9). The “Camera Movement Program 700” can function independently from Parallax Program 800 and Shader Program 900. Parallax Program 800 is dependent on the Camera Movement Program 700. Shader Program 900 is dependent on Parallax Program 800 and the video frame texture coming into 910. These functional steps can even be achieved with one or more programs.

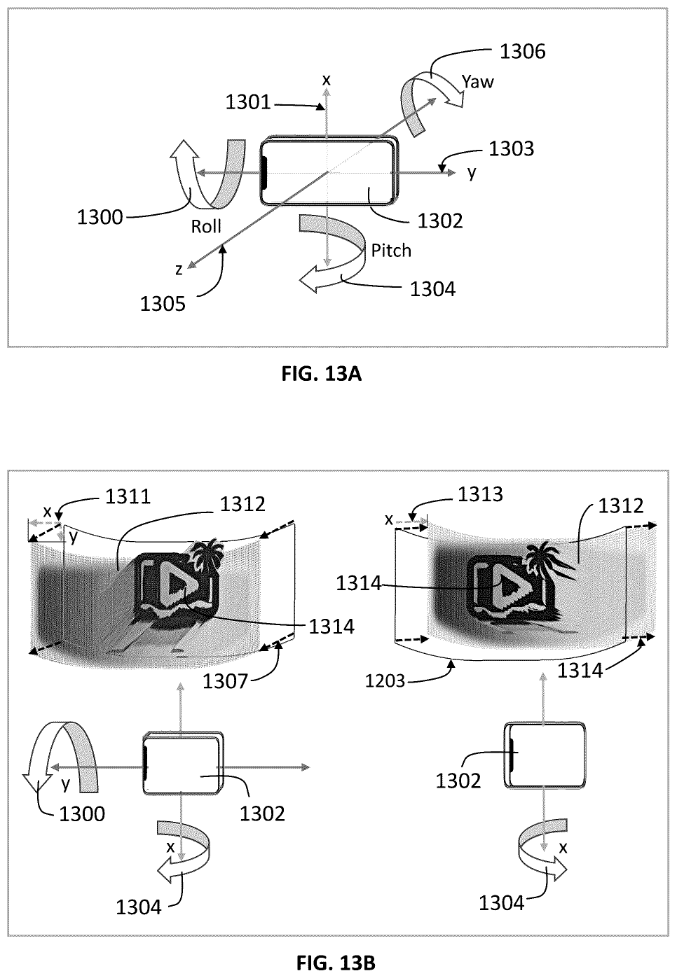

As shown in FIG. 7, Camera Movement Program (700): The process begins with the system reading and sending values from devices such as smartphone's gyroscope and/or accelerometer (701), which have built-in motion sensors. FIG. 13A shows the sensors within a smartphone in landscape orientation, but this can apply to any device with the motion sensor. Depending on how you rotate or turn the device (1302), the sensors register the rotation value of the x, y and z axis (1301, 1303 and 1305). Rotating the x-axis is called Pitch (1304), rotating the y-axis is called Roll (1300) and rotating the z-axis is called Yaw (1306).

To obtain real-time sensor data (702), and determining the target transform (703), which may include the desired position and orientation of the 3D object on the screen.

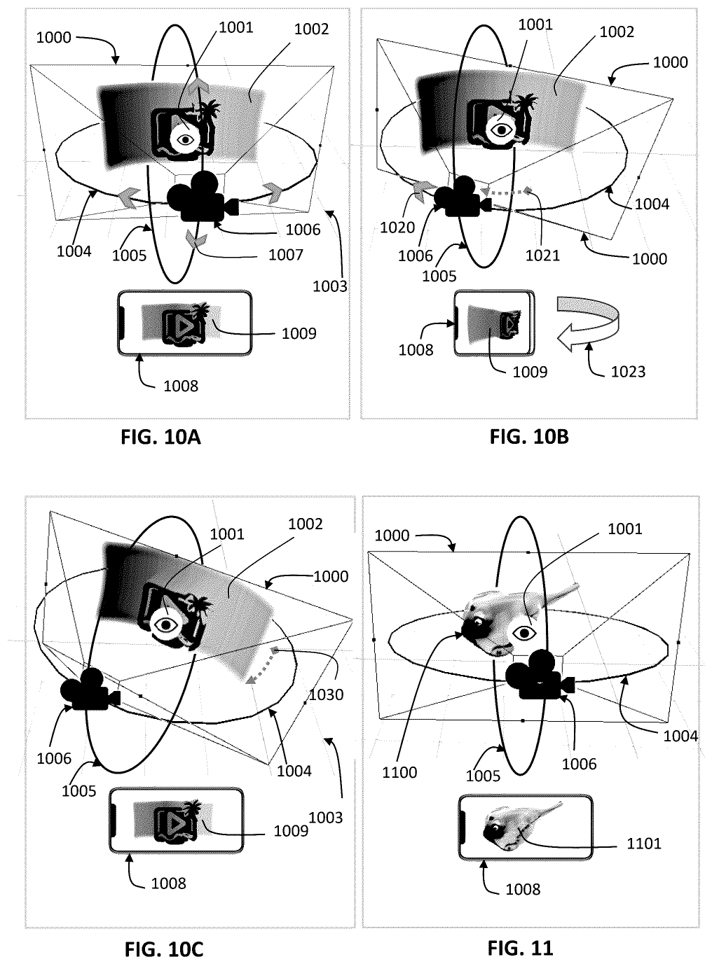

The program will lock onto this transform (704), adjust away distance radius (705) or the distance from the camera. FIGS. 10A & 10B, shows a camera (1006) and the target transform with the ‘eye’ symbol (1001). The camera lock of onto the target transform regardless of the content nearby i.e., curved rectangular mesh (1002). 1004 and 1005 indicate the orbit around the target and travels along a sphere. The movement of the camera locks onto a target within a spherical space and its ability to travel along the sphere based on a radius (1007, 1020). This system is called six degrees of freedom (6DoF). The six degrees of freedom include three translational movements and three rotational movements, which are:

### Translational Movements:

Moving up and down (heave);
Moving left and right (sway);
Moving forward and backward (surge).

### Rotational Movements:

Rotating around the vertical axis (yaw);
Rotating around the longitudinal axis (roll);
Rotating around the lateral axis (pitch).

A gyroscope can measure the rotational movement around the three axes, providing the yaw, roll, and pitch data. When these rotational movements are combined with translational movement data (from other sensors like accelerometers or even GPS), the system can indeed track or simulate six degrees of freedom. This allows an object to freely move in 3D space along the surface of a sphere, thus calculating the position and rotation of the camera relative to the target (706). The system will then dynamically update the camera's position and based on the rotational movements (1023) of the camera controlled by the devices, which then follows an orbit path in real-time (707) as shown in 1021. Element 1008 shows an example of a smartphone rotated clockwise and the camera (1006) travels in a clockwise direction (1020) following a path (indicated by the dotted arrow 1021), along an orbit (1004, 1005).

In applications like virtual reality, augmented reality, spatial computing, robotics, or 3D simulation, 6DoF is essential for creating a realistic representation of movement within a three-dimensional environment. If a device tracks or simulates movement along a sphere with a set radius (assuming it can also rotate in all directions), then it is employing all six degrees of freedom.

The camera position (708) is independently checked or tracked by the parent object transform assign to the 3D content (1002) such as 3D videos. As shown in FIG. 11 The camera position tracking can also apply to any 3D content, where the 3D content is a string ray fish 3D object (1100) and is attached to a parent object transform. All the same logic applies with the camera (1006) and the target transform with the ‘eye’ symbol (1001), where 1004 and 1005 indicate the orbit around the target and travels along a sphere. The movement of the camera locks onto a target within a spherical space and its ability to travel along the sphere based on a radius. Element 1101 shows what the sting ray will look like on a smartphone screen.

As shown in FIG. 10C, the parent object transform (1002) adjusts its rotation and position to point toward the camera (709). Element 1006 shows the camera has moved along to a different position and 1030 shows the path the 3D content has followed to face or point towards the camera, while the camera remains locked on the target (1001).

If there are any objects within the parent object, these are referred to as “children object/s”. The child objects will also adjust its position and rotation to be in line with the parent object (710).

A shown in FIG. 8, Parallax Program (800): This program takes over to further enhance the 3D effect. It receives the sensor data (801) from a device as shown in FIG. 13A. However, only the x (1301) and y (1303) values are required. The rotation speed rates (802) are extracted from sensor values. The x and y angle are extracted to form a vector (803), which are essential for adjusting the 3D perspective. The mesh shader from the shader program (900) is then loaded (804) into memory. The x and y angle sensor values are sent to the shader program (805) in real-time to alter the appearance of a 3D mesh. As shown in FIGS. 12 and 13B, 1203 is mesh before the influence of the parallax program and 1312 shows the mesh's 3D appearance altered after the parallax programs send the x and y angles to the Shader Program (900).

A shown in FIG. 9, Shader Program (900): This programs flowchart outlines the steps taken by the shader program, which is at the heart of rendering a 3D video for displaying onto a device:

The shader program begins by receiving x and y values via the device sensor sent from the Parallax program (800), which is used for curving the mesh (901) on the z-axis or depth extrusion. This is essential for giving the 3D background a more 3D appearance. As shown in FIG. 13A, sensors value for x (1304) and y (1300) are received into the program.

It then determines the curvature based on a depth offset (902), a step that translates depth information into visual curvature on the mesh. The depth offset is the maximum distance a vertex can extrude away from the source point. In FIG. 13B, on the left side, Element 1314 shows a logo extruding (1314) away from the source (1203). However, the back of the mesh (1312) moves the most, while the logo (1314) remains its original position. Element 1311 shows the movement of a mesh along both x-axis (1304) and y-axis (1300). 1307 is the resultant vector movement caused by the combined rotation of the sensor (in this case a smartphone). On the right side of FIG. 13B, element 1313 shows the horizontal movement of a mesh along both x-axis (1304) only and the resultant vector.

The appropriate curvature of the displayed content is determined by utilizing a mathematical algorithm (903). This algorithm takes into account a depth offset, which is derived from the depth map associated with the 3D content. While the precise mathematical method is part of the proprietary technology of the system, the general concept involves adjusting the curvature of the mesh to correspond with the perceived depth from the user's perspective. This process is dynamically computed to ensure that the curvature accurately reflects the intended 3D effect, thereby enhancing the realism of the content. The implementation of the curvature algorithm is designed to work in such a way that the depth and curvature are seamlessly integrated, providing a continuous and immersive viewing experience.

The borders of the mesh are identified (904) through polygon edge detection as show in FIG. 12, element 1204. A transparent gradient with border thickness is applied (905) to give the mesh edges a smooth, faded appearance (1204).

The shader program fades the fragments (“Frag”) with smoothing steps (906), a technique that refers to anti-aliasing or similar smoothing effects. In the context of shaders, “Frag” refers to fragments. A fragment is a term used in OpenGL and other graphics APIs to describe the data necessary to generate a single pixel's color on the screen in the fragment shader stage. The fragment shader is responsible for determining the final color and other attributes of each pixel, which can include applying textures, lighting, and color transformations.

The step of fading fragments with smoothing steps (906) indicates a process in which the shader algorithm adjusts the color and transparency of each fragment to minimize harsh edges or visible steps between depth levels. This is akin to anti-aliasing, which is a technique used to smooth out jagged lines or pixelation that can occur when representing a high-resolution image on a lower resolution display. By implementing this step, the shader ensures that the curvature of the mesh does not result in visual artifacts that would break the immersion, such as “staircase” effects along curves.

Anti-aliasing and similar smoothing effects are critical for maintaining visual fidelity in digital graphics, particularly when transforming 2D images into a 3D representation. These techniques can vary from simple averaging of color values at edges to more complex sub-pixel calculations that deliver higher-quality results.

By fading the fragments, the shader ensures that the edges where different depths meet are rendered with a gradient rather than a sharp division. This gradient allows for a more realistic representation of curved surfaces and edges, enhancing the perceived quality of the 3D content.

Within the system's pipeline, the reception of the video frame as a texture (Step 910) is a crucial juncture where visual data is prepared for 3D rendering. A video frame in RGB/A format contains color information (Red, Green, Blue) and/or an Alpha channel for transparency. The shader program is engineered to receive this texture from a video that will be applied to the mesh—and process it to serve as the visible surface of the 3D representation.

After the texture is received, the shader program performs a pivotal operation of segregating the RGB/A data from the depth map (Step 911). This depth map encodes the z-axis information—the third dimension of depth—for each corresponding pixel in the RGB/A texture. The process of splitting is designed to handle the data separately in the subsequent rendering stages. The RGB/A data will be used to color the vertices of the mesh, providing the surface detail, while the depth map will inform how those vertices are positioned in three-dimensional space to achieve the perception of depth.

The depth information can be encoded in various ways, such as a grayscale image where lighter values represent areas closer to the viewer and darker values represent areas further away, or as a colorized depth image with a broader range of depth values. By separating these two components, the shader can individually manipulate the texture's appearance and the mesh's form to render a cohesive 3D image. The separation step is meticulous, ensuring that there is no loss of depth fidelity, which is vital for maintaining the integrity of the 3D illusion.

The shader program's ability to independently adjust the color and depth aspects of the video frame allows for a dynamic rendering process. As the viewing orientation changes—either landscape or portrait as shown in FIG. 5 and FIG. 6—the program recalculates the necessary parameters to ensure the 3D content appropriately matches the new perspective. This flexibility is central to providing a consistent and immersive 3D experience across varying device orientations and user interactions. In addition to the dynamic processing capabilities of the shader program, the system also includes fixed shader programs specifically tailored to landscape or portrait-oriented videos. These dedicated shader programs are optimized for use when the video input strictly adheres to one of the two orientations. When a video is known to be exclusively in landscape orientation, the corresponding shader program is employed, which has been finely tuned to maximize the rendering efficiency and visual quality for the wider aspect ratio inherent to landscape videos. Similarly, for content that is strictly portrait-oriented, a specialized shader program is activated, designed to enhance the display of content in the vertical format.

The existence of these fixed shader programs ensures that the system can operate with maximum efficiency when the orientation of the content is predetermined, eliminating the need for real-time calculations related to orientation switching. This results in a streamlined rendering process, allowing for quicker load times and potentially higher frame rates or resolution, which is particularly beneficial for static content that does not require orientation responsiveness.

By providing both adaptable and fixed shader programs, the system caters to a wide array of content types and user scenarios, from interactive applications that demand real-time orientation changes to static playback where orientation is constant. This dual approach in the design of the shader programs ensures that regardless of how the video content is presented, the system delivers an optimal viewing experience tailored to the specific characteristics of the content.

In step 912, the system determines the vertices' distance from the origin, a crucial step for translating the two-dimensional depth map into a three-dimensional display. Each vertex on the mesh corresponds to a pixel or a group of pixels in the depth map. The “origin” in this context typically refers to a reference point in the 3D space of the rendering system, often considered the point from which the camera or viewer's perspective is calculated.

By analyzing the depth map, the system assigns a distance value to each vertex, essentially pushing vertices away from or pulling them towards the origin based on the depth information. Darker shades on the grayscale depth map might represent vertices that are further away, while lighter shades indicate vertices that are closer. For an inverse depth map, the opposite is true with Darker shades represent vertices that are closer, while lighter shades indicate vertices that are further away. The shader uses these distances to manipulate the z-coordinate of each vertex, creating the illusion of depth. This process allows flat images to be presented with apparent volume and space, providing the viewer with a more lifelike and immersive visual experience.

Once the 3D positions of the vertices are established, step 913 involves mapping the original 2D video texture onto the now three-dimensional mesh using UV texture coordinates. UV mapping is a process where every vertex in the mesh is assigned a coordinate that corresponds to a point on the 2D texture. The U-axis runs horizontally, and the V-axis runs vertically across the texture, enabling each point on the mesh to be accurately covered by the texture.

The shader program performs complex calculations to ensure that the texture adheres to the contours of the mesh, maintaining the correct aspect ratio and avoiding any visual distortion that could occur due to the curvature or shape of the mesh. This includes adjusting the texture mapping for vertices that have been moved significantly from their original positions due to the depth perception calculations.

Proper UV mapping is essential, especially when dealing with 3D representations, as it ensures that the textures—the visible details like colors, patterns, and any graphical elements—appear correctly on the 3D surface. By preserving the integrity of the video frame's appearance even after the vertices have been displaced to create depth, the shader program guarantees that the final rendered image retains the visual fidelity of the original 2D frame.

### 4. a Method for a Bespoke 2D User Interface (UI) Adaptation on a Smartphone for Displaying 3D Videos or 3D Content

The present invention introduces a method for adapting a 2D user interface for the display of 3D content on smartphones in landscape orientation, addressing the ergonomic and accessibility needs of diverse users. It particularly caters to the natural hand positions and gestures of both right-handed and left-handed users, ensuring a comfortable and intuitive interaction with the device.

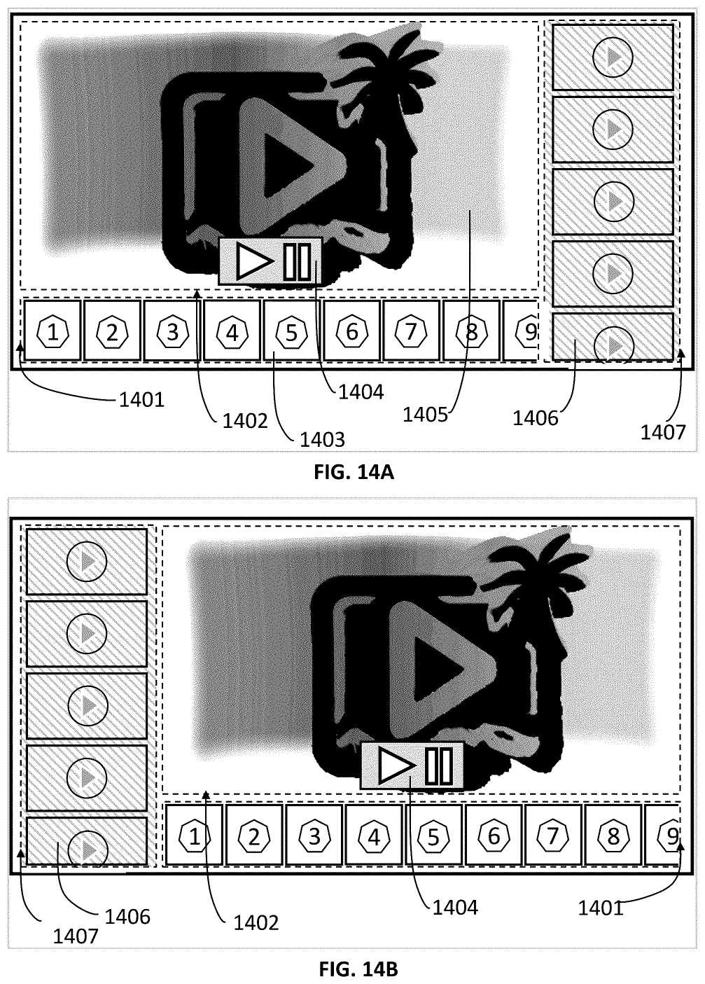

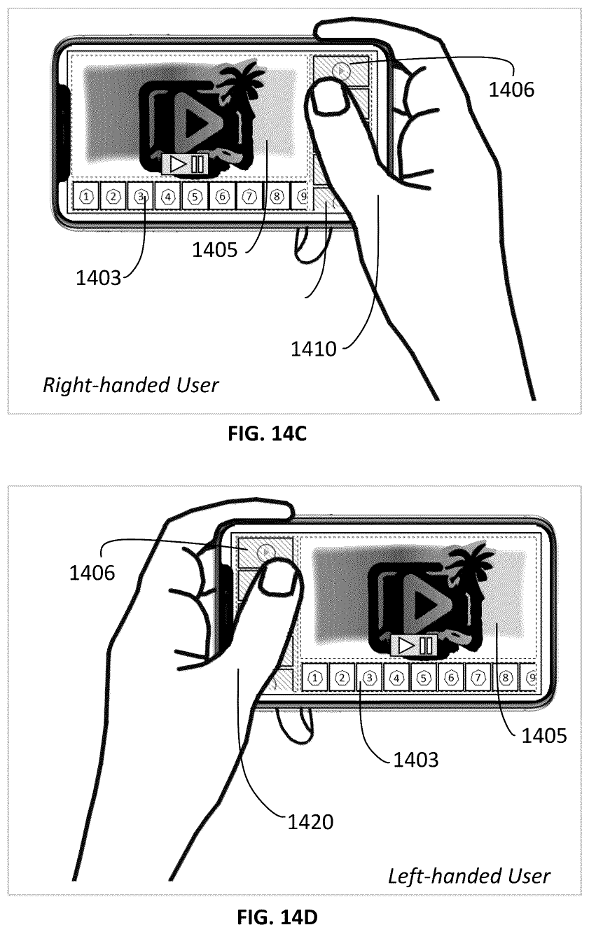

As illustrated in FIGS. 14A and 14B, the UI features a central zone (1402) for the display of 3D content (1405), with crucial interactive elements, such as content selection buttons (1406), positioned to be within easy reach of the user's thumb (1407. For a right-handed user, these buttons are located on the right side of the screen (FIG. 14C, element 1410), ensuring that the selection of content is a seamless and unobtrusive process. Conversely, for left-handed users, the interface adapts by mirroring the layout, placing interactive elements on the left side (FIG. 14D, element 1420), thereby maintaining ease of access and usability.

The UI further includes a dedicated area (1401) for additional options or channels, positioned at the bottom left for right-handed users and bottom right for left-handed users. This bespoke approach means channel selection doesn't occur as much as content selection.

The adaptability of the UI also encompasses the processing and transmission of content. Utilizing scalable depth maps, the system can efficiently adjust the level of 3D effect to match the device's display capabilities and the current network conditions. This scalability ensures that high-quality 3D content is delivered without unnecessary data usage, facilitated by advanced streaming technologies that adapt in real-time to provide an optimal balance of quality and performance.

In summary, the invention presents a 2D UI adaptation method that not only enhances the viewing experience of 3D content or 3D videos on smartphones but also embodies a user-centric design philosophy. It exemplifies how technological innovation can align with ergonomic principles to create a user interface that is both accessible and tailored to the individual preferences and needs of the user.

The provided drawings illustrate various components and processes involved in the system and method for real-time 3D reconstruction of videos. FIG. 1A depicts a high-level block diagram of the system for converting two-dimensional video content into three-dimensional video. The process begins with the 2D video source, labelled as 100, which is then transferred to servers, labelled as 101. These servers are equipped with an AI processing module, labelled as 102, which facilitates the conversion of the 2D video into a 3D format by generating depth maps and performing necessary calculations. The processed 3D video is then sent to a streaming system or broadcaster, labelled as 103, which uses various transmission protocols like HTTP/S, HLS, and DASH over TCP and UDP to deliver the 3D content to user devices, labelled as 110.

In FIG. 1B, a more detailed view of the user device, labelled as 110, is shown. This device could be a smartphone, virtual reality headset, augmented reality glasses, laptop, personal computer, or holographic device. The user device contains sensors, labelled as 111, such as gyroscopes and accelerometers, which detect the device's orientation and motion. The 3D engine, labelled as 112, consisting of a CPU, GPU, and shader, manages the processing and rendering of the 3D content. The streaming receiving system, labelled as 113, includes connectivity options like Wi-Fi and various wireless network technologies (e.g., 5G, 6G) and supports multiple streaming protocols (HLS, DASH, TCP, UDP, HTTP/S). The I/O interface, labelled as 114, facilitates communication between the device's components or with external devices. The display, labelled as 115, serves as the visual interface for the user, presenting the reconstructed 3D video content.

FIG. 2 illustrates the method of processing video for 3D representation. The process starts with receiving a pre-rendered video frame via streaming, labelled as 200. The video frame is then passed to a shader program, labelled as 201, which separates the RGB/A data from the depth map, labelled as 202. The vertices' distance from the origin is determined, labelled as 203, followed by calculations on the mesh based on UV coordinates, labelled as 204. Sensor data, labelled as 205, from gyroscopes and accelerometers is checked to adjust the perspective of the 3D video frame. The new combined calculations are applied to the mesh, labelled as 206, and the mesh values for each vertex are displayed via the shader program, labelled as 207. This process continues for the next frame, labelled as 208.

FIGS. 3A and 3B show different wireframe mesh configurations. FIG. 3A presents a curved 3D wireframe mesh with front and side views, labelled as 300 and 301 respectively. FIG. 3B shows a flat rectangular 3D wireframe mesh with front and side views, labelled as 302 and 303 respectively. These meshes enhance depth perception, creating a more realistic and engaging visual experience.

FIGS. 4A, 4B, and 4C illustrate how the 3D wireframe mesh appears on a smartphone. FIG. 4A shows a curved 3D wireframe mesh, labelled as 401, on the smartphone display, labelled as 402. FIG. 4B shows a flat rectangular 3D wireframe mesh, labelled as 300, on the smartphone display, labelled as 402. FIG. 4C shows a 3D logo on the smartphone screen, labelled as 403. The darker areas of the logo are visually extruded from the base mesh, creating a pronounced 3D effect. When the smartphone is rotated, labelled as 404, the side view, labelled as 405, becomes more prominent, accentuating the extrusion and showcasing the depth that the mesh is capable of rendering.

FIG. 5 depicts various frame layouts for landscape-oriented videos. The RGB/A video frames are labelled as 500, and the corresponding depth maps are labelled as 501. These frame layouts demonstrate the system's flexibility in handling various video formats and optimizing transmission efficiency. The system supports multiple configurations: frame layout 1, labelled 503 shows an example of RGB/A video frames and depth maps arranged top-down. Frame layout 2, labelled as 504, provides another configuration where the frames are organized side by side, differently to optimize for specific rendering or processing requirements. Frame layout 3, labelled as 505, offers yet another layout top-down option, emphasizing how the system can adapt to different video formats. Frame layout 4, labelled as 506, continues to show alternative side by side configuration, highlighting the system's versatility. Frame layout 5, represents a compressed format labelled 509, where the depth map and RGB/A data are compacted to reduce file size and bandwidth usage. The arrows, labelled as 508, indicate the compression process, and the final compressed layout can be top or bottom labelled as 509.

FIG. 6 illustrates frame layouts for portrait-oriented videos, similar to those in FIG. 5, but optimized for vertical display. The RGB/A video frames are labelled as 600, and the corresponding depth maps are labelled as 601. The frame layouts in portrait orientation include frame layout 1, side by side layout, labelled as 603, where the RGB/A video frames and depth maps are arranged to fit a vertical format. Frame layout 2, top-down layout, labelled as 604, shows another configuration optimized for portrait mode. Frame layout 3, top-down layout, labelled as 605, provides an alternative layout option for vertical display. Frame layout 4, side by side, labelled as 606, further illustrates the system's ability to adapt to different formats for portrait-oriented videos. Frame layout 5, labelled as 609, represents the compressed format for portrait orientation, with arrows labelled as 608 indicating the compression process. Frame layout 5 in its uncompressed form is labelled as 606 or Frame layout 4. These detailed configurations demonstrate the system's capability to efficiently manage and transmit 3D video data across various orientations and formats, ensuring optimal performance and visual quality.

FIG. 7 describes a system utilizing smartphone sensors to enhance the 3D content viewing experience using a camera movement program, labelled as 700, and a parallax program, labelled as 800. The process begins with reading and sending gyroscope and accelerometer values, labelled as 701, obtaining real-time sensor data, labelled as 702, and determining the target transform, labelled as 703. The system locks onto this transform, labelled as 704, adjusts the away distance radius, labelled as 705, and calculates the position and rotation of the camera relative to the target, labelled as 706. The system dynamically updates the camera's position and rotation based on device motion, labelled as 707, and checks the camera position, labelled as 708. The parent object transform adjusts its rotation and position to point toward the camera, labelled as 709, and the child objects adjust their position and rotation to be in line with the parent object, labelled as 710. The parallax program, labelled as 800, further enhances the 3D effect by utilizing the sensor data to create a dynamic parallax effect, providing a more immersive viewing experience.

FIG. 8 details the parallax program, labelled as 800, which further enhances the 3D effect. The parallax program receives sensor data, labelled as 801, determines rotation rates, labelled as 802, extracts x and y vectors, labelled as 803, and loads the mesh shader, labelled as 804. The x and y sensor values are sent to the shader program, labelled as 805, to alter the appearance of a 3D mesh. The shader program, labelled as 900, is responsible for curving the mesh and making adjustments based on the sensor data to create a dynamic and immersive 3D viewing experience.

FIG. 9 outlines the shader program's steps, which include receiving x and y values for curving the mesh, labelled as 901, determining curvature based on depth offset, labelled as 902, applying curvature using mathematical calculations, labelled as 903, finding borders of the mesh, labelled as 904, applying a transparent gradient with border thickness, labelled as 905, and fading fragments with smoothing steps, labelled as 906. The shader program also receives the video frame as a texture, labelled as 910, splits RGB/A and depth map, labelled as 911, determines vertices' distance from origin, labelled as 912, applies calculations on the mesh based on UV coordinates, labelled as 913, combines depth and curvature calculations, labelled as 920, and displays mesh values for each vertex, labelled as 921.

FIG. 10A illustrates a scenario within a 3D environment where the forward-facing camera, labelled as 1006, is locked onto a target transform, labelled as 1001. The 3D content is represented by elements labelled as 1002, and the horizonal plane in a grid form is labelled 1003. The camera's movement is constrained within an orbital path, depicted by the paths labelled as 1004 and 1005, which ensures that the camera maintains a consistent perspective relative to the target transform.

The camera's movement direction around the target is indicated by arrows labelled as 1007. This directional movement shows how the camera follows the path around the target transform. The numeral 1009 indicates a connection or additional view related to the camera's position and the 3D content.

Another part of the system setup is labelled as 1000, which represents the camera's field of view of the environment. Additionally, 1008 might be used to indicate a specific configuration or adjustment related to the camera or the 3D content.

FIG. 10B illustrates the side-facing camera, labelled as 1006, locked onto a target transform, labelled as 1001, within a 3D environment. The 3D content is represented by elements labelled as 1002. The camera is constrained to move within an orbital path, depicted by the paths labelled as 1004 and 1005, ensuring the camera maintains a consistent perspective relative to the target transform.

The camera's movement direction to the left is indicated by arrows labelled as 1020, which show how the camera follows the path around the target transform. The numeral 1009 indicates a connection or additional view related to the camera's position and the 3D content. Element 1021 shows the specific path taken by the camera as it moves around the target transform.

The camera's position is dynamically updated based on rotational movements, labelled as 1023, ensuring that the camera remains locked onto the target transform. The numeral 1008 indicates a configuration or adjustment related to the camera or 3D content. Element 1000 represents the camera's field of view of the environment.

FIG. 10C illustrates a scenario where the side-facing camera, labelled as 1006, is locked onto a target transform, labelled as 1001, within a 3D environment. The 3D content is represented by elements labelled as 1002. The camera is constrained to move within an orbital path, depicted by the paths labelled as 1004 and 1005, ensuring that the camera maintains a consistent perspective relative to the target transform.

The camera's movement direction is shown by the path labelled as 1030, indicating the clockwise direction around the target. The numeral 1009 indicates a connection or additional view related to the camera's position and the 3D content. The target transform 1001 represents the focus point of the camera's movement.

Additional elements include another part of the 3D content, labelled as 1003, which represents the horizonal plane where the content resides. Element 1000 indicates represents the camera's field of view of the environment. Element 1008 shows an example of a configuration or adjustment related to the camera or 3D content.

FIG. 11 illustrates a scenario where the forward-facing camera, labelled as 1006, is locked onto a target transform, labelled as 1001, within a 3D environment. The 3D content, labelled as 1100, is shown in relation to the camera and the target transform. The camera is constrained to move within an orbital path, depicted by the paths labelled as 1004 and 1005, ensuring that the camera maintains a consistent perspective relative to the target transform.

The camera's movement direction is shown by the path labelled as 1005, indicating the orbital constraints within which the camera moves. The numeral 1009 indicates a connection or additional view related to the camera's position and the 3D content. The target transform 1001 represents the focus point of the camera's movement.

Additional elements include the 3D content, labelled as 1100, which might represent a different layer or aspect of the content. Element 1101 indicates a representation of what the 3D content will look like on a smartphone screen. Element 1000 represents the camera's field of view of the environment. Element 1008 shows an example of a configuration or adjustment related to the camera or 3D content.

FIG. 12 illustrates various views of a 3D video mesh labelled 1201 to demonstrate the system's capability to maintain a consistent and convincing 3D representation from different angles. The front-bottom view is labelled as 1202, showing the 3D mesh labelled 1201 from a low vantage point, emphasizing how the depth and structure of the mesh appear from below. The front-top view is labelled as 1205, depicting the 3D mesh from an elevated perspective, which highlights the topographical features and the spatial arrangement from above. The side view is labelled as 1204, illustrating the 3D mesh from a lateral angle, providing a clear view of the depth and layering of the mesh along its horizontal axis. The outline of the 3D mesh in an unaltered form before the parallax program is labelled 1203. The 3D mesh's transparent gradient border is labelled 1206. These multiple views demonstrate the system's versatility in delivering a uniform and continuous holographic image adaptable to the user's position and device orientation. This comprehensive illustration confirms the system's ability to provide an immersive and realistic 3D experience across various viewing angles.

FIG. 13A illustrates the sensors within a smartphone in landscape orientation, which can apply to any device with a motion sensor. The diagram includes the x-axis, labelled as 1301, representing the axis associated with pitch, which refers to the rotation around the side-to-side axis of the device. The smartphone itself, or the device containing the sensors, is indicated by numeral 1302. The y-axis, labelled as 1303, represents the axis associated with roll, referring to the rotation around the front-to-back axis of the device. The value for the x-axis rotation, also known as pitch, is indicated by numeral 1304. The z-axis, labelled as 1305, represents the axis associated with yaw, referring to the rotation around the vertical axis of the device. The value for the z-axis rotation, also known as yaw, is indicated by numeral 1306. These sensors, including the gyroscope and accelerometer within the smartphone, detect and register the device's rotational values along the x, y, and z axes, allowing the system to adjust the 3D content's perspective in real-time based on the device's orientation and motion.

FIG. 13B illustrates a 3D video mesh from various views, showing how the parallax program morphs the 3D mesh with movement from the sensors on the user device. The numeral 1300 represents the y-axis rotation, known as roll. The device, labelled as 1302, shows the sensor positions within a smartphone or similar device. The x-axis rotation value, known as pitch, is indicated by 1304.

The resultant vector movement caused by the combined rotation of the sensors is labelled as 1307. This vector shows the combined effect of pitch and roll on the mesh. Element 1311 represents the movement of the mesh in response to the sensors' input along both the x and y axes. The numeral 1312 shows the altered 3D appearance of the mesh after the parallax program sends the x and y angles to the shader program, demonstrating how the 3D video is rendered to reflect these movements.

The element labelled 1313 indicates the horizontal movement of the mesh along the x-axis. The numeral 1314 shows a logo extruding away from the source (1203) after the influence of the parallax program, demonstrating how the 3D effect is enhanced. The mesh before the influence of the parallax program is labelled as 1203, showing the original state before the x and y values are applied.

The altered 3D appearance of the mesh, labelled as 1312, shows the effects of the parallax program. This change is illustrated by the combined rotation values applied to the mesh. The reference numerals 1300 and 1304 indicate the mesh's vertical and horizontal respective movements due to the x-axis and y-axis rotational values of the device, emphasizing how these values influence the 3D rendering.

FIG. 14A illustrates the default or right-handed user interface (UI) for quick access to 3D content on a smartphone. The central zone, labelled as 1402, is designated for displaying the 3D content. This central display area ensures that the 3D video or content, labelled as 1405, is prominently featured for optimal viewing.

Interactive elements, such as content selection buttons, are labelled as 1406. These buttons are positioned within easy reach of the user's thumb, labelled as 1407, to facilitate quick and intuitive access to different content options. The UI layout ensures that these interactive elements are conveniently placed on the right side of the screen for right-handed users, making it easy to navigate and select content without obstructing the view of the 3D display.

The numeral 1401 indicates a dedicated area for additional options or channels, positioned at the bottom left for right-handed users. This area provides access to secondary features or settings, ensuring that the main display remains uncluttered and focused on the 3D content. Interactive elements such as channel selection buttons are labelled as 1403.

The overall design of this UI, labelled as 1407, is tailored to the ergonomic needs of right-handed users, ensuring that all interactive elements are easily accessible and that the user experience is smooth and comfortable. The numeral 1404 shows a pause and play button to suspend or resume 3D playback.

FIG. 14B illustrates the left-handed user interface (UI) for quick access to 3D content on a smartphone. The central zone, labelled as 1402, is designated for displaying the 3D content. This central display area ensures that the 3D video or content is prominently featured for optimal viewing.

Interactive elements, such as content selection buttons, are labelled as 1406. These buttons are positioned within easy reach of the user's thumb to facilitate quick and intuitive access to different content options. For left-handed users, these interactive elements are conveniently placed on the left side of the screen, ensuring easy navigation and content selection without obstructing the view of the 3D display.

The numeral 1401 indicates a dedicated area for additional options or channels, positioned at the bottom left for left-handed users. This area provides access to secondary features or settings, ensuring that the main display remains uncluttered and focused on the 3D content.

The layout configuration, labelled as 1407, is tailored to the ergonomic needs of left-handed users, ensuring that all interactive elements are easily accessible and that the user experience is smooth and comfortable. The numeral 1404 shows a pause and play button to suspend or resume 3D playback.

FIG. 14C illustrates the user interface (UI) layout optimized for right-handed users on a smartphone, demonstrating the efficient one-finger access to content by the thumb. The central zone is designated for displaying the 3D content, ensuring that the 3D video or content, labelled as 1405, is prominently featured for optimal viewing.

Interactive elements, such as content selection buttons, are labelled as 1406. These buttons are positioned within easy reach of the user's thumb, ensuring quick and intuitive access to different content options. For right-handed users, these interactive elements are conveniently placed on the right side of the screen to facilitate easy navigation and content selection without obstructing the view of the 3D display.

The numeral 1410 indicates the efficient one-finger access area designed specifically for right-handed users. This area ensures that all interactive elements, including the content selection buttons, are easily accessible with minimal hand movement, enhancing the user experience.

Interactive elements such as channel selection buttons are labelled as 1403. This design showcases the ergonomic consideration given to right-handed users, ensuring that the user interface is both functional and comfortable to use.

FIG. 14D illustrates the user interface (UI) layout optimized for left-handed users on a smartphone, demonstrating efficient one-finger access to content by the thumb. The central zone is designated for displaying the 3D content, ensuring that the 3D video or content, labelled as 1405, is prominently featured for optimal viewing.

Interactive elements, such as content selection buttons, are labelled as 1406. These buttons are positioned within easy reach of the user's thumb, ensuring quick and intuitive access to different content options. For left-handed users, these interactive elements are conveniently placed on the left side of the screen, facilitating easy navigation and content selection without obstructing the view of the 3D display.

The numeral 1420 indicates the efficient one-finger access area designed specifically for left-handed users. This area ensures that all interactive elements, including the content selection buttons, are easily accessible with minimal hand movement, enhancing the user experience.

Interactive elements such as channel selection buttons are labelled as 1403. This design showcases the ergonomic consideration given to left-handed users, ensuring that the user interface is both functional and comfortable to use.

The present invention also includes a bespoke 2D user interface (UI) adaptation on a smartphone for displaying 3D videos or holographic content. This dynamically adjustable UI configures video selection options on the screen's right or left side to accommodate right-handed or left-handed viewers. For right-handed users, the video selection is placed on the right, covering up to one-third or one-quarter of the screen in both landscape and portrait orientations. The 3D content or 3D video is positioned at the top-left to the center, and the channel selections are at the bottom-left. For left-handed users, these elements are mirrored to the left side, with the 3D content or 3D video at the top-right to the center, and channel selections at the bottom-right, giving the advantage of using one's thumb to easily reach video content selection.

The 3D or holographic video content is displayed prominently, occupying the majority of the screen space. The UI provides the option to position the video feed at the top left or top right, ensuring minimal obstruction by UI elements. This allows the 3D content to be deliberately smaller to occupy the majority of the screen or to cover the full screen under the UI elements, depending on the user's preference.

Additionally, the UI includes a pause and/or play button within easy reach for users to control the playback of 3D videos or holographic content. This feature enhances the viewing experience by allowing seamless interaction without detracting from the content immersion. The dynamically adjustable UI ensures that all interactive elements are easily accessible, providing a smooth and comfortable user experience tailored to both right-handed and left-handed users.

This method of adapting the UI for displaying 3D videos or holographic content on smartphones ensures an ergonomic and user-friendly interface. By positioning interactive elements strategically, users can easily navigate and select content, thereby enhancing the overall viewing experience. The seamless integration of playback controls further contributes to an immersive and interactive 3D video experience.

Examples described herein can also be used in various other scenarios and for various purposes. It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The present description has been shown and described with reference to the foregoing examples. It is understood, however, that other forms, details, and examples can be made without departing from the spirit and scope of the present subject matter.

What is claimed is:

1. A method for real-time 3D reconstruction of videos, comprising:
receiving a two-dimensional (2D) video frame at a processing system;
processing the visual data in the 2D video frame to determine spatial geometry using an artificial intelligence (AI) algorithm, generating a depth map for the 2D video frame;
separating the depth map from the 2D video frame into distinct RGB/A and depth components;
mapping the RGB/A component onto a 3D mesh based on UV coordinates;
adjusting the vertices of the 3D mesh according to the depth component; and
rendering the 3D video frame on a display device in real-time.

2. The method of claim 1, further comprising:
receiving real-time sensor data from a user device, wherein the sensor data includes gyroscope and accelerometer readings; and
adjusting the perspective of the 3D video frame based on the sensor data to create a dynamic parallax effect.

3. The method of claim 2, further comprising:
locking a camera position onto a target transform within a 3D environment, a 3D content or a 3D game; and
updating the camera's position and rotation based on the device's motion to maintain the 3D illusion.

4. The method of claim 1, wherein the depth map is colorized to provide a broader range of depth values.

5. The method of claim 1, further comprising:
compressing the depth map to reduce the file size and bandwidth requirements for transmission; and
transmitting the combined RGB/A and depth map data using adaptive streaming technologies including Dynamic Adaptive Streaming over HTTP (DASH) or HTTP Live Streaming (HLS).

6. The method of claim 1, wherein the 3D mesh includes a curved rectangular or square two-dimensional mesh that conforms to the shape of a sphere.

7. The method of claim 6, further comprising:
applying a shader program to render the 3D vertices on the curved mesh, enhancing the perception of depth.

8. The method of claim 1, wherein the rendering of the 3D video frame includes applying a transparent gradient border to the 3D mesh edges.

9. The method of claim 1, wherein the display device is capable of dynamically switching between landscape and portrait orientations, with the 3D rendering adjusting accordingly.

10. The method of claim 1, further comprising:
implementing a dynamically adjustable user interface (UI) that configures video selection options on the display device's right or left side to accommodate right-handed or left-handed users;
displaying the 3D video frame prominently, occupying the majority of the display device;
including a pause and/or play button for users to control the playback of the 3D video frame.

11. The method of claim 1, further comprising:
applying color correction to the RGB/A component to enhance the visual quality of the 3D video frame.

12. The method of claim 1, further comprising:
integrating ambient occlusion effects to the 3D video frame to improve the perception of depth and realism.

13. The method of claim 1, further comprising:
supporting real-time multi-user interaction with the 3D video content, allowing multiple users to view and manipulate the content simultaneously on their respective devices.

14. The method of claim 1, further comprising:
implementing an adaptive lighting system that adjusts the illumination of the 3D video frame based on the ambient light detected by the user device's sensors.

15. A system for real-time 3D reconstruction of videos, comprising:
a processing system configured to receive a two-dimensional (2D) video frame;
an artificial intelligence (AI) module configured to process the visual data in the 2D video frame to determine spatial geometry and generate a depth map for the 2D video frame;
a separation module configured to separate the depth map from the 2D video frame into distinct RGB/A and depth components;
a mapping module configured to map the RGB/A component onto a 3D mesh based on UV coordinates;
a vertex adjustment module configured to adjust the vertices of the 3D mesh according to the depth component; and
a rendering engine configured to render the 3D video frame on a display device in real-time.

16. The system of claim 15, further comprising:
a sensor interface module configured to receive real-time sensor data from a user device, including gyroscope and accelerometer readings; and
a perspective adjustment module configured to adjust the perspective of the 3D video frame based on the sensor data to create a dynamic parallax effect.

17. The system of claim 16, further comprising:
a camera control module configured to lock a camera position onto a target transform within a 3D environment, a 3D content, or a 3D game; and
a motion update module configured to update the camera's position and rotation based on the device's motion to maintain the 3D illusion.

18. The system of claim 15, wherein the depth map is colorized to provide a broader range of depth values.

19. The system of claim 15, further comprising:
a compression module configured to reduce the file size and bandwidth requirements for transmission by compressing the depth map; and
a transmission module configured to transmit the combined RGB/A and depth map data using adaptive streaming technologies including Dynamic Adaptive Streaming over HTTP (DASH) or HTTP Live Streaming (HLS).

20. The system of claim 15, wherein the 3D mesh includes a curved rectangular or square two-dimensional mesh that conforms to the shape of a sphere or any round shape.

21. The system of claim 20, further comprising:
a shader program module configured to render the 3D vertices on the curved mesh, enhancing the perception of depth.

22. The system of claim 15, wherein the rendering engine is configured to apply a transparent gradient border to the 3D mesh edges.

23. The system of claim 15, wherein the display device is capable of dynamically switching between landscape and portrait orientations, with the 3D rendering adjusting accordingly.

24. The system of claim 15, further comprising:
implementing a dynamically adjustable user interface (UI) that configures video selection options on the display device's right or left side to accommodate right-handed or left-handed users;
displaying the 3D video frame prominently, occupying the majority of the display device;
including a pause and/or play button for users to control the playback of the 3D video frame.

25. A non-transitory computer-readable medium storing instructions that, when executed by a processor, cause the processor to perform a method for real-time 3D reconstruction of videos, the method comprising:
receiving a two-dimensional (2D) video frame at a processing system;
processing the visual data in the 2D video frame to determine spatial geometry using an artificial intelligence (AI) algorithm, generating a depth map for the 2D video frame;
separating the depth map from the 2D video frame into distinct RGB/A and depth components;
mapping the RGB/A component onto a 3D mesh based on UV coordinates;
adjusting the vertices of the 3D mesh according to the depth component; and
rendering the 3D video frame on a display device in real-time.
